(19) United States
(12) Patent Application Publication
(10) Pub. No.: US 2007/0065777 A1
(43) Pub. Date: Mar. 22, 2007

(54) METHOD AND APPARATUS FOR PERFORMING DENTAL IMPLANTATION

(76) Inventor: Robert Becker, Bloomfield Hills, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/464,348

(22) Filed: Aug. 14, 2006

Related U.S. Application Data
(60) Provisional application No. 60/707,693, filed on Aug. 12, 2005.

(51) Int. Cl. A61C 8/00; A61C 3/02

(52) U.S. Cl. 433/173; 433/165

(57) ABSTRACT

In a dental implantation, after exposure of the alveolar crest and drilling a pilot hole into the crest, a novel mill having an axial guide pin which extends into the pilot hole is used to form clearance for a cover screw or temporary healing abutment. The pilot hole is then enlarged to form clearance for the implant and the screw or abutment is attached.

### RELATED APPLICATION

This application claims priority of U.S. Provisional Patent Application Ser. No. 60/707,693 filed Aug. 12, 2005, which is incorporated herein by reference.

### FIELD OF THE INVENTION

This invention relates to a method and apparatus for dental implantation of a prosthetic and more particularly to a method and apparatus for forming a clearance in crestal bone for placement of a cover screw or temporary abutment on an implant.

### BACKGROUND OF THE INVENTION

In a conventional dental implantation process after exposure of the alveolar crest by either surgical flap or mucosal punch, the first step is the drilling of a small diameter guide hole, typically 2 mm in diameter, into the alveolar ridge of a living jawbone at the location at which the implant is to be placed and along the axis of the intended implant. This guide hole is centered at the location on which the implant is to be performed. The guide hole is then enlarged with a bone drill or the like and the implant is installed. A cover screw or healing abutment is then inserted into the top of the implant to seal its interior bone and shoulder. The top of the implant usually lies at or below the crestal bone and is then allowed to heal and integrate to the bone for a period of months. In cases where a cover screw is placed, a secondary surgical procedure is performed to expose the implant and the cover screw is removed and replaced with a healing abutment. In the case of placement of the healing abutment at the time of implant placement, the secondary surgical procedure is unnecessary. Both the cover screw and the healing abutments are usually wider in diameter than the implant body or shoulder so either subcrestal implant positioning or crestal bone form that is at some point coronal to the top of the implant often results in the inability to properly seat the cover screw, the healing abutment or an impression device. When successful healing has occurred, a prosthetic device may be secured to the implant.

U.S. Pat. No. 5,868,572 discloses a bone mill which may be used to enlarge the crestal bone opening following the first stage healing process and before insertion of the healing abutment. A bone mil has a hollow central bore and a guide pin may be screwed into the implant to center the bone mill during enlargement of the cortical bone area to create a base for the healing abutment and subsequent to the prosthetic restoration.

This process tends to exert forces which may cause displacement of the loosely supported implant particularly where the bone quality is poor, and/or misalignment between the pin and the mill.

### SUMMARY OF THE INVENTION

The present invention is directed to an alternative process in which the cortical bone is prepared to form a proper space for receipt of a cover screw or healing abutment prior to insertion of the implant. This is done by using the initial small diameter guide hole as a receptacle for an axially extending post from a unique bone mill. Following formation of the initial guide hole into the implant site, and prior to the enlarging of the hole and the insertion of the implant, the extending post of the novel bone mill is inserted into the guide hole and the crestal bone of the alveolar ridge is milled to form a space for receipt of the cover screw or healing abutment. Following formation of this enlarged area in or through the cortical bone and the underlying subcrestal bone, the hole is enlarged to receive the implant, which is then installed and either a cover screw or healing abutment attached which seats in the milled area. Alternatively, an impression device may be inserted into the milled site before the cover screw or healing abutment is attached. After the suitable healing period, a second stage exposure is performed if a cover screw was inserted and later a prosthetic device is attached to the implant.

The new bone mill, while not necessarily replacing the function of the old mill, works beyond the capability of the old mill and can be used in clinical situations with limited inter-occlusal space where the old mill cannot be used.

Since the bone crest is often not horizontal or flat in the facial-lingual and/or mesio-distal aspect, placement of an implant at crestal level in one aspect of the ridge crest often results in subcrestal positioning in another aspect. This condition prevents proper seating of either the cover screw or healing abutment. Purposeful subcrestal placement of the coronal aspect of the implant further exacerbates the problem of proper placement of the cover screw or healing abutment.

Another application for the bone mill is when performing the mucosal punch procedure which does not require reflection of muco-gingival flaps prior to implant placement. A tissue punch of appropriate diameter is used to remove the soft tissue over the bony ridge prior to the osteotomy. While the mucosal punch procedure simplifies the implant surgery, it does not permit good visualization of the bony topography.

Utilization of the bone mill immediately after the preparation with the 2 mm drill would reduce the problem of differing bony heights around the osteotomy. Attempting to eliminate bone height irregularities after implant placement is particularly difficult in the mucosal punch procedure because of restricted visibility.

### BRIEF DESCRIPTION OF THE DRAWINGS

Other objects, advantages and applications of the invention will be made apparent by the following detailed description of preferred embodiments of the invention. The description makes reference to the attached drawings, in which:

FIGS. 1A-C illustrate successive steps in a method employing a novel tool to form a seat for a dental implant;

FIGS. 2A-C illustrate similar steps in a case involving a mesio-distal ridge irregularity; and FIGS. 3A-C illustrate the method as performed on a ridge presenting a facio-lingual irregularity.

### DETAILED DESCRIPTION OF THE INVENTION

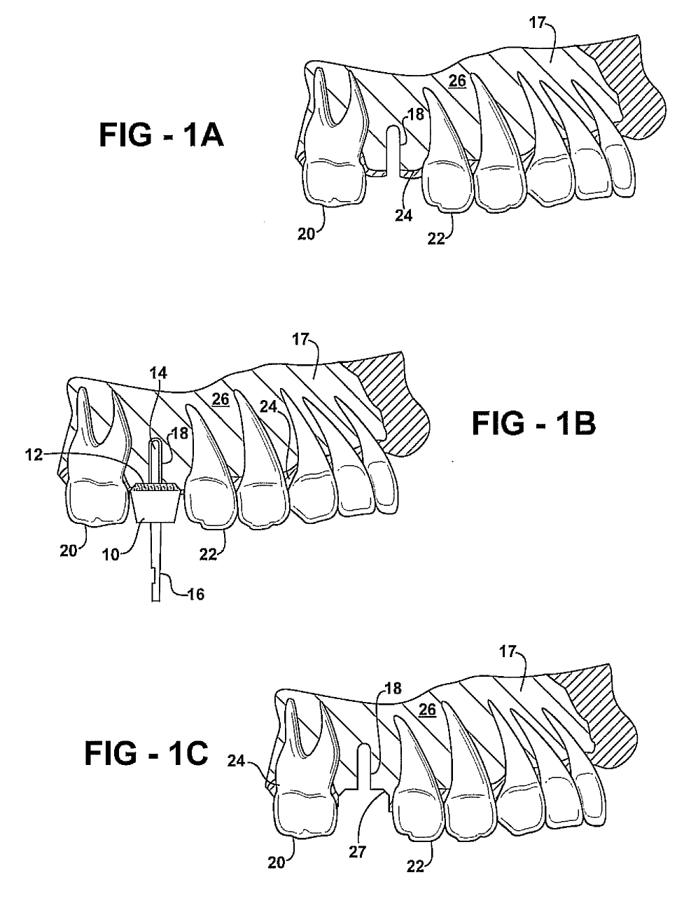

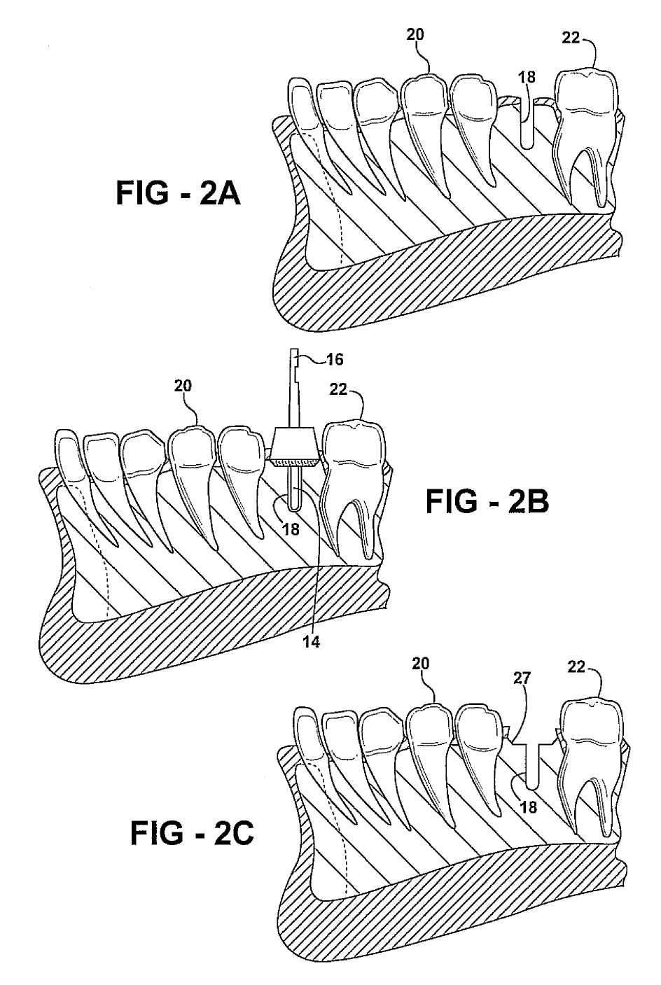

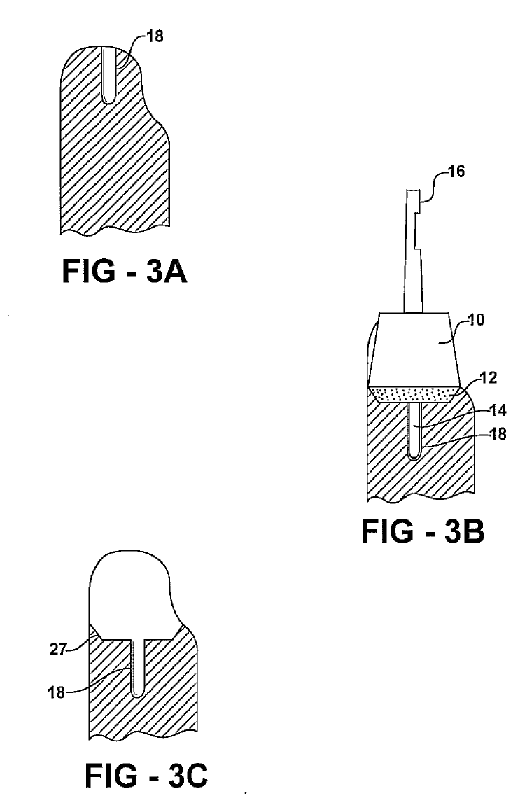

The mill formed in accordance with the present invention, as illustrated in FIGS. 1B and 2B, consists of a cylindrical body 10 having beveled cutting teeth 12 arrayed about one end. A guide post 14, of 2 mm in diameter, extends axially from the cutting end. A driving stem 16, of conventional design, for use with a dental driving tool, extends centrally from the opposite end.

FIGS. 1A, 1B and 1C illustrate use of the mill in an upper jaw 17 between two teeth 20 and 22. A 2 mm diameter pilot hole 18 is first drilled through the crestal bone 24 and subcrestal bone 26 at the location of the desired implant as shown in FIG. 1A. Then as shown in FIG. 1B, the guide post 14 of the mill is placed in the pilot hole 18 to align the mill for forming a recess 27 which accommodates the healing abutment and subsequently the implant. The resulting prepared site, ready for the enlargement of the hole 18 to receive an implant and an abutment or cover screw is shown in FIG. 1C. If the mill won't fit between the adjacent teeth, the dentist is alerted for the need to modify the procedure at this early stage, before the installation of the implant, so the prosthetic will fit.

Case II illustrates the process in the situation of a mesio-distal irregularity, and case III a facial-lingual irregularity.

Having thus described my invention, I claim:

1. The method of placing a dental implant in an alveolar ridge, comprising:
drilling a guide hole in the alveolar ridge along the axis of the implant;
milling a seat in the crestal bone of the alveolar ridge using a mill having an axial guidepost which extends into the guide hole to form a clearance for a cover screw or healing abutment;
enlarging the guide hole to form a receptacle for the implant;
placing the implant in the receptacle; and
attaching either a cover screw or a healing abutment to the implant.

2. The method of claim 1, further comprising:
extending the seat milled into the crestal bone into the subcrestal bone.

3. A mill for dental implant use, comprising:
a cylindrical mill body having an array of inclined cutting teeth formed at one end adapted to eliminate crestal bone interference for proper seating of a cover screw, temporary healing abutment or impression device;
a guide pin extending axially from the toothed end of the mill of a size adapted to be inserted into a pilot hole formed in the crestal and subcrestal bone; and
a driving stem extending centrally from the opposite end of the mill body.
